(19) United States
(12) Patent Application Publication
(10) Pub. No.: US 2025/0235294 A1
(43) Pub. Date: Jul. 24, 2025

(54) SELF-LIGATING ORTHODONTIC BRACKET

(71) Applicant: Hirsch Dynamics Holding AG, Wollerau (CH)

(72) Inventor: Markus HIRSCH, Wollerau (CH)

(73) Assignee: Hirsch Dynamics Holding AG, Wollerau (CH)

(21) Appl. No.: 18/417,910

(22) Filed: Jan. 19, 2024

(51) Int. Cl. A61C 7/28

(52) U.S. Cl. CPC A61C 7/287

(57) ABSTRACT

A self-ligating orthodontic bracket comprising a bracket body having a base with a bonding surface, two wall portions, a mesial-distal arch wire slot formed by the base and the two wall portions and extending in a labial direction of the bracket body, and a door channel oriented essentially perpendicular to the arch wire slot. A covering door is movable in the door channel from a closed position suitable for occluding the arch wire slot and an open position opening the arch wire slot the covering door being secured via a pre-loaded securing device, for holding the covering door in the closed or open position. Wherein the bracket body comprises a lock part and the covering door comprises a counter-lock part for locking the covering door in the closed position with the bracket body on an opposite side of the arch wire slot with respect to the door channel.

### BACKGROUND

The present invention relates to a self-ligating orthodontic bracket, comprising:
a bracket body having a base with a bonding surface, two wall portions, a mesial-distal arch wire slot formed by the base and the two wall portions and extending in a labial direction of the bracket body, and a door channel oriented essentially perpendicular to the arch wire slot,
at least one covering door suitable for occluding the arch wire slot in a closed position and opening the arch wire slot in an open position, the at least one covering door being essentially linear moveable between the closed position and the open position in the door channel and
at least one securing device, wherein the at least one securing device is pre-loaded for holding the at least one covering door in the closed position or in the open position.

State of the art is the U.S. Patent application US2022-0202537A1 which discloses a self-ligating orthodontic bracket. This orthodontic bracket provides besides others the following benefits:
easy to assemble,
user-friendly approach to reliably secure the at least one covering door in the closed state and/or the open state.

Unfortunately, the pre-loaded securing device for the self-ligating orthodontic bracket can result in a at least partial loose and/or contorted and/or distorted assembly of the orthodontic bracket. Subsequently, gaps between parts of the orthodontic bracket may occur which is disadvantageous due to contamination and/or damage of these parts.

### SUMMARY

The object of the present invention is to at least partially remedy the disadvantages of the state of the art and to specify a self-ligating orthodontic bracket which is improved compared with the state of the art and improves the lifetime of the self-ligating orthodontic bracket.

U.S. Patent application US 2022-0202537 A1, application Ser. No. 17/131,849, is incorporated herein by reference in its entirety.

This object is achieved by the features of claims 1, 2 and 14.

This object is achieved according to a first aspect of the invention by means of a self-ligating orthodontic bracket, comprising:
a bracket body having a base with a bonding surface, two wall portions, a mesial-distal arch wire slot formed by the base and the two wall portions and extending in a labial direction of the bracket body, and a door channel oriented essentially perpendicular to the arch wire slot,
at least one covering door suitable for occluding the arch wire slot in a closed position and opening the arch wire slot in an open position, the at least one covering door being essentially linear moveable between the closed position and the open position in the door channel and
at least one securing device, wherein the at least one securing device is pre-loaded for holding the at least one covering door in the closed position or in the open position,
   wherein the bracket body comprises a lock part and the at least one covering door comprises a counter-lock part for locking the at least one covering door in the closed position with the bracket body on an opposite side of the arch wire slot with respect to the door channel.

This object is achieved according to a second aspect of the invention by means of a self-ligating orthodontic bracket, comprising:
a bracket body having a base with a bonding surface, two wall portions, a mesial-distal arch wire slot formed by the base and the two wall portions and extending in a labial direction of the bracket body, and a door channel oriented essentially perpendicular to the arch wire slot,
at least one covering door suitable for occluding the arch wire slot in a closed position and opening the arch wire slot in an open position, the at least one covering door being essentially linear moveable between the closed position and the open position in the door channel and
at least one securing device, wherein the at least one securing device is pre-loaded for holding the at least one covering door in the closed position or in the open position,
   wherein the bracket body comprises a lock part and the at least one covering door comprises a counter-lock part for locking the at least one covering door in the closed position with the bracket body on an occlusal side of the arch wire slot.

This object is achieved according to a third aspect of the invention by means of a self-ligating orthodontic bracket, comprising:
a bracket body having a base with a bonding surface, two wall portions, a mesial-distal arch wire slot formed by the base and the two wall portions and extending in a labial direction of the bracket body, and a door channel oriented essentially perpendicular to the arch wire slot,
at least one covering door suitable for occluding the arch wire slot in a closed position and opening the arch wire slot in an open position, the at least one covering door being essentially linear moveable between the closed position and the open position in the door channel along a plurality of intermediate positions and
at least one securing device, wherein the at least one securing device is pre-loaded for holding the at least one covering door in an occlusal-gingival direction in the closed position or in the open position,
   wherein the orthodontic bracket comprises at least two engagement positions for the at least one securing device, wherein the at least two engagement positions are separated from one another in an occlusal-gingival direction, wherein the at least one securing device is movable between the at least two engagement positions by a movement of the at least one covering door along the door channel,
wherein a first engagement position corresponds to the open position and provides an engagement of the at least one covering door with the bracket body by the securing device on the gingival side of the arch wire slot and
a second engagement position corresponds to the closed position and provides an engagement of the at least one covering door with the bracket body by the securing device on the gingival side of the arch wire slot and provides a locking of the at least one covering door with the bracket body by a lock part and a counter-lock part on the occlusal side of the arch wire slot.

Since the orthodontic bracket experiences a tension effect due to the pre-loaded securing device and/or an arch wire there is the risk of an at least partial disassembling of the orthodontic bracket, in particular in the labial direction. Due to the locking of the lock part and the counter-lock part on an opposite side of the arch wire slot with respect to the door channel or on the occlusal side of the arch wire slot, respectively, a loosening and/or contortion and/or distortion of the orthodontic bracket in the closed position can be prevented or at least reduced resulting in a longer life time of the self-ligating orthodontic bracket.

Further advantageous embodiments of the orthodontic bracket are defined in the dependent claims.

According to a preferred embodiment of the orthodontic bracket, it is provided that the at least one covering door comprises at least one notch, the at least one notch extending in a lingual direction, wherein the at least one securing device is arranged at least partially inside the at least one notch, wherein the at least one notch secures the at least one securing device in a labial direction in the closed position and the open position, wherein the at least one covering door occludes the at least one securing device exhaustively in labial direction.

According to a preferred embodiment of the orthodontic bracket, it is provided that the at least one covering door is securable by the at least one securing device in the open position and in the closed position in the gingival direction and the occlusal direction.

According to a preferred embodiment of the orthodontic bracket, it is provided that the bracket body or the at least one covering door or both the bracket body and the at least one covering door comprises at least one depression along the arch wire slot for insertion of a tool inside the at least one depression to move the at least one covering door from the closed position to the open position.

According to a preferred embodiment of the orthodontic bracket, it is provided that the bracket body or the at least one covering door comprises at least one depression along the arch wire slot and the bracket body or the at least one covering door comprises a protrusion corresponding to the at least one depression, wherein the protrusion is introducible into the at least one depression of the bracket body or the at least one covering door in the closed position.

According to a preferred embodiment of the orthodontic bracket, it is provided that the door channel comprises at least one recess in a mesial-distal direction, wherein the at least one covering door is arranged in the at least one recess, the at least one covering door being movable between the closed position and the open position along the at least one recess in an occlusal-gingival direction.

According to a preferred embodiment of the orthodontic bracket, it is provided that the locking of the at least one covering door with the bracket body in the closed position is based on a positive locking, a frictional connection, an adhesive connection or a combination thereof.

According to a preferred embodiment of the orthodontic bracket, it is provided that the locking of the at least one covering door with the bracket body in the closed position is configured to lock a motion of the at least one covering door relative to the bracket body in labial-lingual direction.

According to a preferred embodiment of the orthodontic bracket, it is provided that the lock part and the counter-lock part comprise at least one projection, preferably at least two projections, formed on the at least one covering door or the bracket body and at least one corresponding deepening, preferably at least two corresponding deepenings, formed on the at least one covering door or the bracket body in such a way that the at least one projection and the at least one corresponding deepening lock with each other in the closed position of the at least one covering door.

According to a preferred embodiment of the orthodontic bracket, it is provided that the at least one projection and the at least one corresponding deepening are cuboidal, preferably cubic, prism-shaped, wedge-shaped, pyramidal, preferably square pyramidal, cylindrical, spherical, ellipsoid or a combination thereof.

According to a preferred embodiment of the orthodontic bracket, it is provided that the at least one projection and the at least one corresponding deepening have a cross section, preferably orientated perpendicular with respect to the occlusal-gingival direction, being angular, preferably triangular, polygonal, circular, oval or a combination thereof.

According to a preferred embodiment of the orthodontic bracket, it is provided that the bracket body, the at least one covering door and the at least one securing device consist of one of the following materials: metal, plastic, composite material, ceramic or a combination thereof.

The above-mentioned preferred embodiments of the orthodontic bracket defined in the dependent claims can be combined with all three aspects of the invention.

In a preferred embodiment it can be provided that the at least one covering door comprises at least one projection and at least one corresponding deepening and the bracket body comprises at least one projection and at least one corresponding deepening.

In a preferred embodiment it can be provided that the at least one covering door is slidably coupled to the bracket body.

In a preferred embodiment it can be provided that the at least one covering door being essentially linear moveable between the closed position and the open position of the at least one covering door in the door channel.

It is particularly preferred that the at least one recess is concavely curved and the at least one covering door comprises at least one convexly curved outer face corresponding to the at least one recess.

A dovetail-connection of the at least one covering door and the bracket body with two recesses or similar are particularly preferred for a movement of the at least one covering door along the channel.

In some embodiments, the at least one covering door comprises exactly two curved outer faces, wherein an interaction with exactly two recesses prevent the at least one covering door from falling off the bracket body or undesirable movement in a lingual direction and/or enable occlusal-gingival movements of the at least one covering door. If the two curved outer faces are connected to each other by a plane, a wedging tendency during movement of the at least one covering door is reduced—e.g. by a support of the bracket body on the plane.

In a preferred embodiment it can be provided that the at least one securing device being orientated essentially parallel to the arch wire slot.

In a preferred embodiment it can be provided that the at least one securing device is suitable to secure the at least one covering door in an occlusal-gingival direction in the closed position and/or the open position.

In a preferred embodiment it can be provided that the at least one covering door being essentially linear moveable between the closed position and the open position of the at least one covering door along a plurality of intermediate positions.

In a preferred embodiment it can be provided that
one or both of the two side walls comprises a first indent for arranging the at least one securing device at least partially within the first indent to secure the at least one covering door in the occlusal-gingival direction in the closed position, or
one or both of the two side walls comprises a second indent for arranging the at least one securing device at least partially within the second indent to secure the at least one covering door in the occlusal-gingival direction in the open position.

In a preferred embodiment it can be provided that a slope of the at least one second indent in an occlusal direction is lower compared to a slope of the at least one first indent in a gingival direction.

In a preferred embodiment it can be provided that the at least one securing device is essentially rod-shaped or in the form of a curved rod and compressible in a mesial-distal direction to allow sliding movement of the at least one securing device between the closed position and the open position.

In a preferred embodiment it can be provided that the at least one covering door fills the whole door channel essentially completely along an occlusal-gingival extension of the at least one covering door except for the at least one notch.

In a preferred embodiment it can be provided that the at least one securing device is arranged in a plane spanned by a mesial-distal direction and a labial-lingual direction, wherein the at least one securing device
is curved in the plane in the labial-lingual direction and comprises two free ends, a first free end and a second free end enclosing a blunter angle in a labial direction, or
is symmetrical with respect to the labial-lingual direction and comprises a concavely bent section, wherein the concavely bent section borders a first straight section and a second straight section, wherein the first straight section includes the first free end and the second straight section includes the second free end.

In a preferred embodiment it can be provided that the at least one notch comprises at least one indentation in a labial direction for arranging the at least one securing device at least partially within the at least one indentation or a bulge in a lingual direction to secure the at least one securing device in the labial direction, wherein the at least one covering door is movable between the closed position and the open position by bending the at least one securing device in direction of the least one indentation.

In a preferred embodiment it can be provided that a circumference of the at least one securing device is essentially circular, oval or polygonal.

In a preferred embodiment it can be provided that the at least one securing device consists of metal or composite material or the bracket body or the at least one covering door is an injection-molded, a 3D-printed or a milled plastic, metal or ceramics part.

In a preferred embodiment it can be provided that the at least one bracket body comprises at least one inlay, wherein the at least one inlay consists of metal, plastic, composite material, ceramic or a combination thereof and/or the at least one inlay is attached to the at least one arch wire slot or is located at least partially within the at least one bracket body so that an interior surface of the at least one inlay forms or strengthens at least partially the at least one arch wire slot.

The provision of at least one inlay made out of metal, plastic, composite material, ceramic or a combination thereof can increase the fracture resistance of the at least one arch wire slot. As the at least one bracket body is preferably built out of composite material, the at least one inlay can strengthen at least zonally the at least one bracket body, wherein areas with high demands can be reinforced locally by the at least one inlay. Moreover, an aesthetic appearance of the orthodontic bracket can be improved.

The at least one inlay makes it possible that metal, plastic, composite material, ceramic or a combination thereof can be attached to the at least one arch wire slot and/or forms the at least one arch wire slot, wherein the at least one inlay is inserted into the at least one bracket body.

It is advantageous that the at least one inlay is essentially U-shaped, preferably wherein a first leg is longer than a second leg, wherein one leg, preferably the first leg, is arranged on an occlusal side of the arch wire slot.

The U-shape can emulate a shape of the at least one arch wire slot, wherein the legs of the at least one inlay can reinforce the connection of the at least one covering door and the at least one bracket body in the closed position, wherein a possibly too high elastic deformation of the two side wall portions, in particular the side wall portion on an occlusal side of the arch wire slot, can be prevented.

### BRIEF DESCRIPTION OF THE DRAWINGS

Further details and advantages of preferred embodiments of the invention are explained in more detail below with the aid of the description of the figures with reference to the drawings. There are shown in:

FIG. 1 shows a first view on a first embodiment of a self-ligating orthodontic bracket in a first position,

FIG. 2 shows the covering door and the bracket body in an intermediate position;

FIG. 3 shows a side view of the first embodiment of a self-ligating orthodontic bracket;

FIG. 4 shows a side view of the first embodiment of a self-ligating orthodontic bracket in an open position;

FIG. 5: a perspective view on a second embodiment of a bracket body of a self-ligating orthodontic bracket,

FIG. 6: a sectional view of the self-ligating orthodontic bracket in the open position of FIG. 4 with a sectional plane defined by the labial-lingual direction and the mesial-distal direction and running through the securing device,

FIG. 7: a side view of on a third embodiment of a self-ligating orthodontic bracket,

FIG. 8: a sectional view of the lock parts of the second and third embodiment of FIGS. 5 and 7,

FIG. 9 is a view of a fourth embodiment of a self-ligating orthodontic bracket,

FIG. 10 shows another view of the fourth embodiment of FIG. 9;

FIG. 11: a perspective view on a fifth embodiment of a self-ligating orthodontic bracket,

FIG. 12: a perspective view on a sixth embodiment of a self-ligating orthodontic bracket.

### DETAILED DESCRIPTION

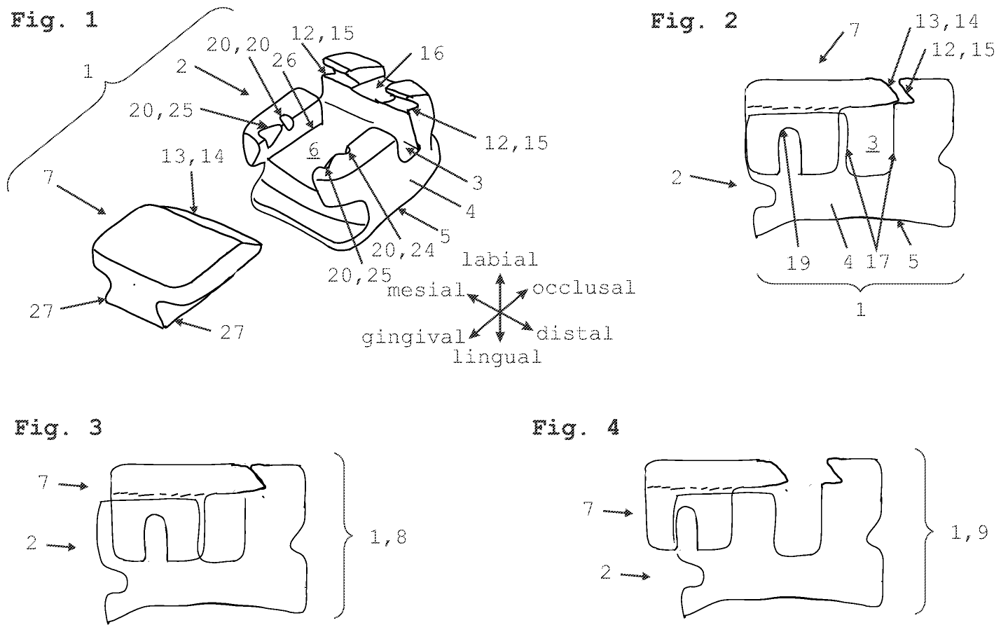

FIG. 1 shows an exploded view on a first embodiment of a self-ligating orthodontic bracket 1.

FIG. 1 shows a self-ligating orthodontic bracket 1, comprising:
a bracket body 2 having a base 4 with a bonding surface 5, two wall portions 17, a mesial-distal arch wire slot 3 formed by the base 4 and the two wall portions 17 and extending in a labial direction of the bracket body 2, and a door channel 6 oriented essentially perpendicular to the arch wire slot 3,
at least one covering door 7 suitable for occluding the arch wire slot 3 in a closed position 8 and opening the arch wire slot 3 in an open position 9, the at least one covering door 7 being essentially linear moveable between the closed position 8 and the open position 9 in the door channel 6 and
at least one securing device 10, wherein the at least one securing device 10 is pre-loaded for holding the at least one covering door 7 in the closed position 8 or in the open position 9,
   wherein the bracket body 2 comprises a lock part 12 and the at least one covering door 7 comprises a counter-lock part 13 for locking the at least one covering door 7 in the closed position 8 with the bracket body 2 on an opposite side of the arch wire slot 3 with respect to the door channel 6.

FIG. 1 shows a self-ligating orthodontic bracket 1, comprising:
a bracket body 2 having a base 4 with a bonding surface 5, two wall portions 17, a mesial-distal arch wire slot 3 formed by the base 4 and the two wall portions 17 and extending in a labial direction of the bracket body 2, and a door channel 6 oriented essentially perpendicular to the arch wire slot 3,
at least one covering door 7 suitable for occluding the arch wire slot 3 in a closed position 8 and opening the arch wire slot 3 in an open position 9, the at least one covering door 7 being essentially linear moveable between the closed position 8 and the open position 9 in the door channel 6 and
at least one securing device 10, wherein the at least one securing device 10 is pre-loaded for holding the at least one covering door 7 in the closed position 8 or in the open position 9, wherein the bracket body 2 comprises a lock part 12 and the at least one covering door 7 comprises a counter-lock part 13 for locking the at least one covering door 7 in the closed position 8 with the bracket body 2 on an occlusal side of the arch wire slot 3.

FIG. 1 shows a self-ligating orthodontic bracket 1, comprising:
a bracket body 2 having a base 4 with a bonding surface 5, two wall portions 17, a mesial-distal arch wire slot 3 formed by the base 4 and the two wall portions 17 and extending in a labial direction of the bracket body 2, and a door channel 6 oriented essentially perpendicular to the arch wire slot 3,
at least one covering door 7 suitable for occluding the arch wire slot 3 in a closed position 8 and opening the arch wire slot 3 in an open position 9, the at least one covering door 7 being essentially linear moveable between the closed position 8 and the open position 9 in the door channel 6 along a plurality of intermediate positions and
at least one securing device 10, wherein the at least one securing device 10 is pre-loaded for holding the at least one covering door 7 in an occlusal-gingival direction in the closed position 8 or in the open position 9,
   wherein the orthodontic bracket 1 comprises at least two engagement positions 20 on an outer surface 11 of the bracket body 2 for the at least one securing device 10, wherein the at least two engagement positions 20 are separated from one another in an occlusal-gingival direction, wherein the at least one securing device 10 is movable between the at least two engagement positions 20 by a movement of the at least one covering door 7 along the door channel 6,
wherein a first engagement position 20 corresponds to the open position 9 and provides an engagement of the at least one covering door 7 with the bracket body 2 by the securing device 10 on the gingival side of the arch wire slot 3 and
a second engagement position 20 corresponds to the closed position 8 and provides an engagement of the at least one covering door 7 with the bracket body 2 by the securing device 10 on the gingival side of the arch wire slot 3 and provides a locking of the at least one covering door 7 with the bracket body 2 by a lock part 12 and a counter-lock part 13 on the occlusal side of the arch wire slot 3.

FIG. 1 shows the first embodiment of an orthodontic bracket 1, wherein the lock part 12 and the counter-lock part 13 comprise at least one projection 14, preferably at least two projections 14, formed on the at least one covering door 7 or the bracket body 2 and at least one corresponding deepening 15, preferably at least two corresponding deepenings 15, formed on the at least one covering door 7 or the bracket body 2 in such a way that the at least one projection 14 and the at least one corresponding deepening 15 lock with each other in the closed position 8 of the at least one covering door 7.

The first embodiment of an orthodontic bracket 1 of FIGS. 1 to 4 shows one counter-lock part 13 of the covering door 7 which is a projection 14 and two lock parts 12 of the bracket body 2 which are two corresponding deepenings 15 and which are corresponding to the projection 14.

The amount, form and position of the at least one lock part 12 and the at least one counter-lock part 13 of the described embodiments are not limiting the scope of the invention.

FIGS. 1, 5, 9, 11 and 12 show different embodiments an orthodontic bracket 1, wherein the bracket body 2 or the at least one covering door 7 or both the bracket body 2 and the at least one covering door 7 comprises at least one depression 16 along the arch wire slot 3 for insertion of a tool inside the at least one depression 16 to move the at least one covering door 7 from the closed position 8 to the open position 9.

The first embodiment of an orthodontic bracket 1 of FIGS. 1 to 4 shows an orthodontic bracket 1, wherein the at least one projection 14 and the at least one corresponding deepening 15 are cuboidal, preferably cubic, prism-shaped, wedge-shaped, pyramidal, preferably square pyramidal, cylindrical, spherical, ellipsoid or a combination thereof.

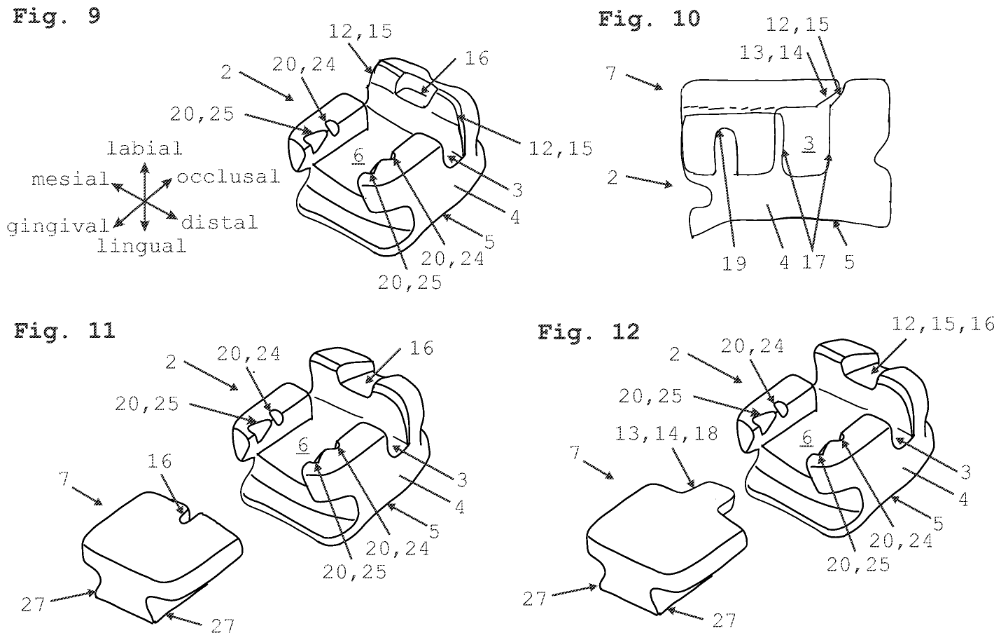

The lock parts 12 and the counter-lock part 13 of the first embodiment of an orthodontic bracket 1 shown in FIGS. 1 to 4 and of the fourth embodiment of an orthodontic bracket 1 in FIGS. 9 and 10 are wedge-shaped.

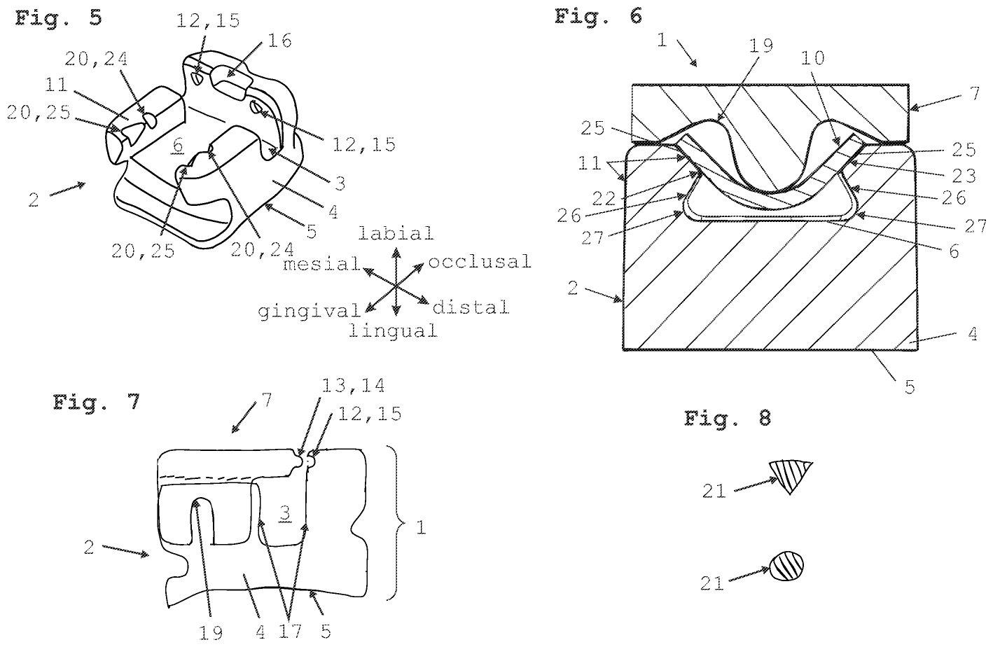

The lock parts 12 and the counter-lock parts 13 of the second embodiment of an orthodontic bracket 1 shown in FIG. 5 are prism-shaped.

The at least one lock part 12 and the at least one counter-lock part 13 of the third embodiment of an orthodontic bracket 1 shown in FIG. 7 can be cylindrical or spherical.

FIG. 2 shows a side view of the first embodiment of a self-ligating orthodontic bracket 1 of FIG. 1 in an intermediate position.

FIG. 2 shows the first embodiment of an orthodontic bracket 1, wherein the locking of the at least one covering door 7 with the bracket body 2 in the closed position 8 is based 4 on a positive locking, a frictional connection, an adhesive connection or a combination thereof.

A positive locking is shown by the first embodiment in the FIGS. 1 to 4, by the second embodiment in the FIG. 5 and by the third embodiment in the FIG. 7.

A frictional connection or an adhesive connection or a combination thereof is shown by the fourth embodiment in the FIGS. 9 to 10, by the fifth embodiment in the FIG. 11 and by the sixth embodiment in the FIG. 12.

In FIG. 2 the covering door 7 and the bracket body 2 are in an intermediate position. In this intermediate position the securing device 10 is positioned between the two engagements positions 20, to be more precise between the first intend 24 and the second intend 25. Thus, the counter-lock part 13 of the covering door 7 and the two lock parts 12 of the bracket body 2 are not completely engaged yet.

FIG. 3 shows a side view of the first embodiment of a self-ligating orthodontic bracket 1 of FIG. 1 in a closed position 8.

FIG. 2 shows the first embodiment of an orthodontic bracket 1, wherein the locking of the at least one covering door 7 with the bracket body 2 in the closed position 8 is configured to lock a motion of the at least one covering door 7 relative to the bracket body 2 in labial-lingual direction.

By the locking of a motion of the covering door 7 in labial-lingual direction, with other words in a labial or a lingual direction, the risk of lifting or bending of the covering door 7 due to the pre-loaded securing device 10 or an arch wire is prevented or at least reduced.

FIG. 4 shows a side view of the first embodiment of a self-ligating orthodontic bracket 1 of FIG. 1 in an open position 9.

FIGS. 3 and 4 show the first embodiment of an orthodontic bracket 1, wherein the at least one covering door 7 is securable by the at least one securing device 10 in the open position 9 and in the closed position 8 in the gingival direction and the occlusal direction.

FIG. 5 shows a perspective view on a second embodiment of a bracket body 2 of a self-ligating orthodontic bracket 1.

The second embodiment of an orthodontic bracket 1 of FIG. 5 shows two lock parts 12 of the bracket body 2 which are two corresponding deepenings 15 and which are corresponding to two projections 14 of the omitted covering door 7.

FIG. 6 shows a sectional view of the self-ligating orthodontic bracket 1 in the open position 9 of FIG. 4 with a sectional plane defined by the labial-lingual direction and the mesial-distal direction and running through the securing device 10.

FIG. 6 shows the first embodiment of an orthodontic bracket 1 of FIG. 4 in the open position 9, wherein the at least one covering door 7 comprises at least one notch 19, the at least one notch 19 extending in a lingual direction, wherein the at least one securing device 10 is arranged at least partially inside the at least one notch 19, wherein the at least one notch 19 secures the at least one securing device 10 in a labial direction in the closed position 8 and the open position 9, wherein the at least one covering door 7 occludes the at least one securing device 10 exhaustively in labial direction.

FIG. 6 shows the first embodiment of an orthodontic bracket 1, wherein the door channel 6 comprises at least one recess 26 in a mesial-distal direction, wherein the at least one covering door 7 is arranged in the at least one recess 26, the at least one covering door 7 being movable between the closed position 8 and the open position 9 along the at least one recess 26 in an occlusal-gingival direction.

In a preferred embodiment it can be provided that the at least one covering door 7 is arranged in the door channel 6 of the bracket body 2 and the door channel 6 comprises an opening 22 in a labial direction, the at least one covering door 7 extending through the opening 22 along two side walls 23 of the opening 22.

The door channel 6 comprises two recesses 26 in a mesial-distal direction, whereby the covering door 7 is arranged in the two recesses 26, wherein the covering door 7 is movable between the closed position 8 and the open position 9 and vice versa along the two recesses 26 in an occlusal-gingival direction, if the securing device 10 does not prevent this movement. The two recesses 26 are concavely curved and the covering door 7 comprises two convexly curved outer faces 27 corresponding to the two recesses 26, viz. the covering door 7 is secured by the bracket body 2 in a labial-lingual direction (due to the channel 6).

FIG. 7 shows a side view of on a third embodiment of a self-ligating orthodontic bracket 1.

The third embodiment of an orthodontic bracket 1 of FIG. 7 shows at least one lock part 12 of the bracket body 2 which is at least one corresponding deepenings 15 and which is corresponding to at least one projection 14 of the covering door 7.

FIG. 8 shows a sectional view of the lock parts 12 of the second and third embodiment of FIGS. 5 and 7 with a sectional plane defined by the labial-lingual direction and the mesial-distal direction and running through the lock parts 12.

In FIG. 8 the sectional view above shows a cross section 21 of one of the two lock parts 12, more precisely one of the two corresponding deepenings 15, of the second embodiment of a self-ligating orthodontic bracket 1 of FIG. 5. Since the corresponding deepenings 15 correspond to the counter-lock parts 13, more precisely to the projections 14 of the covering door 7, the cross section of one of the two counter-lock parts 13 is similar with, preferably essentially the same as, the cross section 21 of the lock parts 12.

In FIG. 8 the sectional view below shows a cross section 21 of the at least one two lock part 12, more precisely the at least one corresponding deepening 15, of the third embodiment of a self-ligating orthodontic bracket 1 of FIG. 7. Since the corresponding deepening 15 corresponds to the counter-lock part 13, more precisely to the projection 14 of the covering door 7, the cross section of one of the at least two counter-lock part 13 is similar with, preferably essentially the same as, the cross section 21 of the at least one lock part 12.

Hence, the at least one projection 14 and the at least one corresponding deepening 15 can have similar, preferably the same, cross sections.

FIG. 8 shows a sectional view of the lock parts 12, more precisely the corresponding deepenings 15, of the second and third embodiment of FIGS. 5 and 7, wherein the at least one projection 14 and the at least one corresponding deepening 15 have a cross section, preferably orientated perpendicular with respect to the occlusal-gingival direction, being angular, preferably triangular, polygonal, circular, oval or a combination thereof.

The lock parts 12 and the counter-lock parts 13 of the second embodiment of an orthodontic bracket 1 shown in FIG. 5 have angular, preferably triangular, cross sections.

The at least one lock part 12 and the at least one counter-lock part 13 of the third embodiment of an orthodontic bracket 1 shown in FIG. 7 have circular cross sections.

FIG. 9 shows a perspective view on a fourth embodiment of a bracket body 2 of a self-ligating orthodontic bracket 1.

Features already explained in the light of the preceding description shall apply analogously for the remaining embodiments of a self-ligating orthodontic bracket 1 of FIGS. 9 to 12.

FIG. 10 shows a side view on the fourth embodiment of a self-ligating orthodontic bracket 1 in an intermediate position.

FIG. 11 shows a perspective view on a fifth embodiment of a self-ligating orthodontic bracket 1.

In FIG. 11 both the bracket body 2 and the covering door 7 comprise one depression 16 for insertion of a tool inside the at least one depression 16 to move the at least one covering door 7 from the closed position 8 to the open position 9.

FIG. 12 shows a perspective view on a sixth embodiment of a self-ligating orthodontic bracket 1.

FIG. 12 shows the sixth embodiment of an orthodontic bracket 1, wherein the bracket body 2 or the at least one covering door 7 comprises at least one depression 16 along the arch wire slot 3 and the bracket body 2 or the at least one covering door 7 comprises a protrusion 18 corresponding to the at least one depression 16, wherein the protrusion 18 is introducible into the at least one depression 16 of the bracket body 2 or the at least one covering door 7 in the closed position 8.

In the case of FIG. 12 the counter-lock part 13 of the covering door is a projection 14 and the lock part 12 of the bracket body 2 is a corresponding deepening 15. The locking between the lock part 12 and the counter-lock part 13 may be established by a frictional connection or an adhesive connection or a combination thereof. The connection may be established between at least one contact surface of the bracket body 2 and at least one contact surface of the covering door 7 on a mesial, distal, labial or lingual site or a combination thereof. In FIG. 12 the bracket body 2 and the covering 7 comprise both three contact surfaces.

At the same time in the case of FIG. 12 the counter-lock part 13 is a protrusion 18 and the lock part 12 is a depression 16 for insertion of a tool inside the depression 16 to move the at least on covering door 7. Preferably the depression 16 is not completely occupied by the introduced protrusion 18 in the closed position 8 so that the tool is still insertable into the depression 16. Hence, the lock part 12 and the counter-lock part 13 may serve for locking and other functionalities like tool insertion, therefor being multifunctional.

### LIST OF REFERENCE SIGNS

1 self-ligating orthodontic bracket
2 bracket body
3 arch wire slot
4 base
5 bonding surface
6 door channel
7 covering door
8 closed position
9 open position
10 securing device
11 outer surface
12 lock part
13 counter-lock part
14 projection
15 corresponding deepening
16 depression
17 wall portion
18 protrusion
19 notch
20 engagement position
21 cross section of the at least one lock part
22 opening
23 side wall
24 first indent
25 second indent
26 recess
27 outer face

1. A self-ligating orthodontic bracket (1), comprising:
a bracket body (2) having a base (4) with a bonding surface (5), two wall portions (17), a mesial-distal arch wire slot (3) formed by the base (4) and the two wall portions (17) and extending in a labial direction of the bracket body (2), and a door channel (6) oriented essentially perpendicular to the arch wire slot (3),
at least one covering door (7) suitable for occluding the arch wire slot (3) in a closed position (8) and opening the arch wire slot (3) in an open position (9), the at least one covering door (7) being essentially linear moveable between the closed position (8) and the open position (9) in the door channel (6) and
at least one securing device (10), wherein the at least one securing device (10) is pre-loaded for holding the at least one covering door (7) in the closed position (8) or in the open position (9),
wherein the bracket body (2) comprises a lock part (12) and the at least one covering door (7) comprises a counter-lock part (13) for locking the at least one covering door (7) in the closed position (8) with the bracket body (2) on an opposite side of the arch wire slot (3) with respect to the door channel (6).

2. A self-ligating orthodontic bracket (1), comprising:
a bracket body (2) having a base (4) with a bonding surface (5), two wall portions (17), a mesial-distal arch wire slot (3) formed by the base (4) and the two wall portions (17) and extending in a labial direction of the bracket body (2), and a door channel (6) oriented essentially perpendicular to the arch wire slot (3),
at least one covering door (7) suitable for occluding the arch wire slot (3) in a closed position (8) and opening the arch wire slot (3) in an open position (9), the at least one covering door (7) being essentially linear moveable between the closed position (8) and the open position (9) in the door channel (6) and
at least one securing device (10), wherein the at least one securing device (10) is pre-loaded for holding the at least one covering door (7) in the closed position (8) or in the open position (9),
wherein the bracket body (2) comprises a lock part (12) and the at least one covering door (7) comprises a counter-lock part (13) for locking the at least one covering door (7) in the closed position (8) with the bracket body (2) on an occlusal side of the arch wire slot (3).

3. The orthodontic bracket (1) according to claim 2, wherein the at least one covering door (7) comprises at least one notch, the at least one notch extending in a lingual direction, wherein the at least one securing device (10) is arranged at least partially inside the at least one notch, wherein the at least one notch secures the at least one securing device (10) in a labial direction in the closed position (8) and the open position (9), wherein the at least one covering door (7) occludes the at least one securing device (10) exhaustively in labial direction.

4. The orthodontic bracket (1) according to claim 2, wherein the at least one covering door (7) is securable by the at least one securing device (10) in the open position (9) and in the closed position (8) in the gingival direction and the occlusal direction.

5. The orthodontic bracket (1) according to claim 2, wherein the bracket body (2) or the at least one covering door (7) or both the bracket body (2) and the at least one covering door (7) comprises at least one depression (16) along the arch wire slot (3) for insertion of a tool inside the at least one depression (16) to move the at least one covering door (7) from the closed position (8) to the open position (9).

6. The orthodontic bracket (1) according to claim 2, wherein the bracket body (2) or the at least one covering door (7) comprises at least one depression (16) along the arch wire slot (3) and the bracket body (2) or the at least one covering door (7) comprises a protrusion (18) corresponding to the at least one depression (16), wherein the protrusion (18) is introducible into the at least one depression (16) of the bracket body (2) or the at least one covering door (7) in the closed position (8).

7. The orthodontic bracket (1) according to claim 2, wherein the door channel (6) comprises at least one recess (26) in a mesial-distal direction, wherein the at least one covering door (7) is arranged in the at least one recess (26), the at least one covering door (7) being movable between the closed position (8) and the open position (9) along the at least one recess (26) in an occlusal-gingival direction.

8. The orthodontic bracket (1) according to claim 2, wherein the locking of the at least one covering door (7) with the bracket body (2) in the closed position (8) is based (4) on a positive locking, a frictional connection, an adhesive connection or a combination thereof.

9. The orthodontic bracket (1) according to claim 2, wherein the locking of the at least one covering door (7) with the bracket body (2) in the closed position (8) is configured to lock a motion of the at least one covering door (7) relative to the bracket body (2) in labial-lingual direction.

10. The orthodontic bracket (1) according to claim 2, wherein the lock part (12) and the counter-lock part (13) comprise at least one projection (14), preferably at least two projections (14), formed on the at least one covering door (7) or the bracket body (2) and at least one corresponding deepening (15), preferably at least two corresponding deepenings (15), formed on the at least one covering door (7) or the bracket body (2) in such a way that the at least one projection (14) and the at least one corresponding deepening (15) lock with each other in the closed position (8) of the at least one covering door (7).

11. The orthodontic bracket (1) according to claim 10, wherein the at least one projection (14) and the at least one corresponding deepening (15) are cuboidal, preferably cubic, prism-shaped, wedge-shaped, pyramidal, preferably square pyramidal, cylindrical, spherical, ellipsoid or a combination thereof.

12. The orthodontic bracket (1) according to claim 11, wherein the at least one projection (14) and the at least one corresponding deepening (15) have a cross section, preferably orientated perpendicular with respect to the occlusal-gingival direction, being angular, preferably triangular, polygonal, circular, oval or a combination thereof.

13. The orthodontic bracket (1) according to claim 2, wherein the bracket body (2), the at least one covering door (7) and the at least one securing device (10) consist of one of the following materials: metal, plastic, composite material, ceramic or a combination thereof.

14. A self-ligating orthodontic bracket (1), comprising:
a bracket body (2) having a base (4) with a bonding surface (5), two wall portions (17), a mesial-distal arch wire slot (3) formed by the base (4) and the two wall portions (17) and extending in a labial direction of the bracket body (2), and a door channel (6) oriented essentially perpendicular to the arch wire slot (3),
at least one covering door (7) suitable for occluding the arch wire slot (3) in a closed position (8) and opening the arch wire slot (3) in an open position (9), the at least one covering door (7) being essentially linear moveable between the closed position (8) and the open position (9) in the door channel (6) along a plurality of intermediate positions and
at least one securing device (10), wherein the at least one securing device (10) is pre-loaded for holding the at least one covering door (7) in an occlusal-gingival direction in the closed position (8) or in the open position (9),
wherein the orthodontic bracket (1) comprises at least two engagement positions (20) on an outer surface (11) of the bracket body (2) for the at least one securing device (10), wherein the at least two engagement positions (20) are separated from one another in an occlusal-gingival direction, wherein the at least one securing device (10) is movable between the at least two engagement positions (20) by a movement of the at least one covering door (7) along the door channel (6),
wherein a first engagement position (20) corresponds to the open position (9) and provides an engagement of the at least one covering door (7) with the bracket body (2) by the securing device (10) on the gingival side of the arch wire slot (3) and
a second engagement position (20) corresponds to the closed position (8) and provides an engagement of the at least one covering door (7) with the bracket body (2) by the securing device (10) on the gingival side of the arch wire slot (3) and provides a locking of the at least one covering door (7) with the bracket body (2) by a lock part and a counter-lock part on the occlusal side of the arch wire slot (3).

15. The orthodontic bracket (1) according to claim 14, wherein the locking of the at least one covering door (7) with the bracket body (2) in the closed position (8) is based (4) on a positive locking, a frictional connection, an adhesive connection or a combination thereof.

16. The orthodontic bracket (1) according to claim 14, wherein the locking of the at least one covering door (7) with the bracket body (2) in the closed position (8) is configured to lock a motion of the at least one covering door (7) relative to the bracket body (2) in labial-lingual direction.

17. The orthodontic bracket (1) according to claim 14, wherein the lock part (12) and the counter-lock part (13) comprise at least one projection (14), preferably at least two projections (14), formed on the at least one covering door (7) or the bracket body (2) and at least one corresponding deepening (15), preferably at least two corresponding deepenings (15), formed on the at least one covering door (7) or the bracket body (2) in such a way that the at least one projection (14) and the at least one corresponding deepening (15) lock with each other in the closed position (8) of the at least one covering door (7).

18. The orthodontic bracket (1) according to claim 17, wherein the at least one projection (14) and the at least one corresponding deepening (15) are cuboidal, preferably cubic, prism-shaped, wedge-shaped, pyramidal, preferably square pyramidal, cylindrical, spherical, ellipsoid or a combination thereof.

19. The orthodontic bracket (1) according to claim 17, wherein the at least one projection (14) and the at least one corresponding deepening (15) have a cross section, preferably orientated perpendicular with respect to the occlusal-gingival direction, being angular, preferably triangular, polygonal, circular, oval or a combination thereof.

20. The orthodontic bracket (1) according to claim 14, wherein the bracket body (2), the at least one covering door (7) and the at least one securing device (10) consist of one of the following materials: metal, plastic, composite material, ceramic or a combination thereof.
